(19) United States
(12) Patent Application Publication
(10) Pub. No.: US 2014/0198998 A1
(43) Pub. Date: Jul. 17, 2014

(54) NOVEL CRITERIA FOR GAUSSIAN MIXTURE MODEL CLUSTER SELECTION IN SCALABLE COMPRESSED FISHER VECTOR (SCFV) GLOBAL DESCRIPTOR

(71) Applicant: Samsung Electronics Co., Ltd., Suwon-si (KR)

(72) Inventors: Gaurav Srivastava, Dallas, TX (US); Zhu Li, Plano, TX (US); Abhishek Nagar, Garland, TX (US); Ankur Saxena, Dallas, TX (US); Zhan Ma, San Jose, CA (US); Felix Carlos Fernandes, Plano, TX (US)

(73) Assignee: Samsung Electronics Co., Ltd., Suwon-si (KR)

(21) Appl. No.: 14/151,657

(22) Filed: Jan. 9, 2014

Related U.S. Application Data
(60) Provisional application No. 61/752,334, filed on Jan. 14, 2013.

(51) Int. Cl. G06F 17/30

(52) U.S. Cl. CPC G06F 17/30277
USPC 382/305

(57) ABSTRACT

A wireless communication device includes a processor configured to execute an image query. The image query utilizes cluster selection criteria for a cluster-aggregation based vectorization of a set of local features based on a quantity of top local features having the highest posteriori probability values. The cluster selection criterion is measured as the summation of the posteriori probability values of the top local features. The quantity of top local features is determined by a predetermined integer value greater than one.

### CROSS-REFERENCE TO RELATED APPLICATION(S) AND CLAIM OF PRIORITY

This application claims priority under 35 U.S.C. §119(e) to U.S. Provisional Patent Application Ser. No. 61/752,334, filed Jan. 14, 2013, entitled “NOVEL CRITERIA FOR GAUSSIAN MIXTURE MODEL CLUSTER SELECTION IN SCALABLE COMPRESSED FISHER VECTOR (SCFV) GLOBAL DESCRIPTOR”. The content of the above-identified application is incorporated herein by reference in its entirety.

### TECHNICAL FIELD

The present application relates generally to correlating images and, more specifically, to correlating images using a wireless communication device.

### BACKGROUND

Mobile visual search and Augmented Reality (AR) applications have been gaining popularity recently with important business values for a variety of players in mobile computing and communication fields. The key technology to enable these applications is a compact local image descriptor that is robust to image recapturing variations and efficient for indexing and query transmission over the air. However, there is need for increased robustness for image capturing variations and increased efficiency for indexing and querying transmission over the air.

### SUMMARY

This disclosure provides a method and system for executing an image query using a wireless communication device.

In a first embodiment, a wireless communication device includes a processor configured to execute an image query. The image query utilizes cluster selection criteria for a cluster-aggregation based vectorization of a set of local features based on a quantity of top local features having the highest posteriori probability values. The cluster selection criterion is measured as the summation of the posteriori probability values of the top local features. The quantity of top local features is determined by a predetermined integer value greater than one.

In a second embodiment, a method of executing an image query using a wireless communication device includes utilizing a cluster selection criterion for a cluster-aggregation based vectorization of a set of local features. The cluster selection criterion is based on a quantity of top local features having the highest posteriori probability values. The method also includes measuring the summation of the posteriori probability values of the top local features. The quantity of top local features is determined by a predetermined integer value greater than one.

In a third embodiment, a wireless communication device includes a processor configured to execute an image query. The image query utilizes cluster selection criteria for a cluster-aggregation based vectorization of a set of local features based on a quantity of top local features. The quantity of top local features has the highest posteriori probability values. The cluster selection criterion is measured as the summation of the posteriori probability values of the top local features. The quantity of top local features is determined by a quantity of local features that have a posteriori probability value greater than a posterior probability value threshold.

In a fourth embodiment, a method of executing an image query using a wireless communication device includes utilizing a cluster selection criterion for a cluster-aggregation based vectorization of a set of local features. The cluster selection criterion is based on a quantity of top local features. The quantity of top local features has the highest posteriori probability values. The method also includes measuring the summation of the posteriori probability values of the top local feature. The quantity of top local features is determined by a quantity of local features that have a posteriori probability value greater than a posterior probability value threshold.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates high level diagram of a network within which visual query processing with a specific cluster selection criteria may be performed in accordance with various embodiments of the present disclosure;

FIG. 2A illustrates a high level block diagram of the functional components of the visual search server from the network of FIG. 1;

FIG. 2B illustrates a front view of a wireless device from the network of FIG. 1;

FIG. 2C illustrates a high level block diagram of the functional components of the wireless device of FIG. 2B;

FIG. 3 illustrates an exemplary embodiment of query processing with Compact Descriptors for Visual Search (CDVS) according to this disclosure;

FIG. 4 illustrates an exemplary embodiment of sparseness values of the K Fisher Vector (FV) sub-vectors gᵢ^{X} according to this disclosure;

FIGS. 5A and 5B illustrate exemplary embodiments of a previous Scalable Compressed Fisher Vector (SCFV) implementation according to this disclosure;

FIG. 6 illustrates an exemplary embodiment of a Gaussian function selection criteria according to this disclosure;

FIG. 7 illustrates an exemplary embodiment of a Gaussian function selection criteria according to this disclosure; and

FIG. 8 illustrates an exemplary embodiment of a method of executing an image query according to this disclosure.

### DETAILED DESCRIPTION

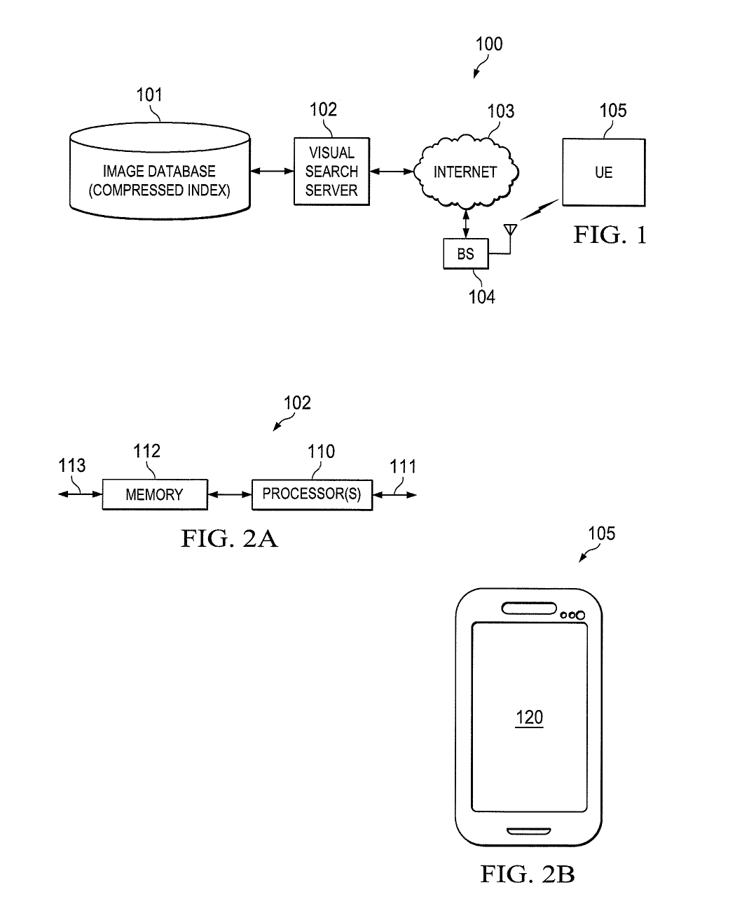

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device.

Aspects, features, and advantages of the disclosure are readily apparent from the following detailed description, simply by illustrating a number of particular embodiments and implementations, including the best mode contemplated for carrying out the disclosure. The disclosure is also capable of other and different embodiments, and its several details can be modified in various obvious respects, all without departing from the spirit and scope of the disclosure.

Accordingly, the drawings and description are to be regarded as illustrative in nature, and not as restrictive. The disclosure is illustrated by way of example, and not by way of limitation, in the figures of the accompanying drawings. In this disclosure, we use limited number and types of base stations or limited number of mobile stations or limited number of service flows or limited number of connections or limited number of routes or limited use cases as an example for illustration. However, the embodiments disclosed in this disclosure are also applicable to arbitrary number and types of base stations, arbitrary number of mobile stations, arbitrary number of service flows, arbitrary number of connections, and other related use cases. Embodiments described here are not limited to base station (BS) and a User Equipment (UE) (BS-UE) communications, but are also applicable to BS-BS, UE-UE communications.

FIG. 1 illustrates high level diagram of a network within which visual query processing with a cluster selection criteria can be performed in accordance with various embodiments of the present disclosure. The network 100 can include a database 101 of stored global descriptors regarding various images (which, as used herein, can include both still images and video), and can include the images themselves. The images can relate to geographic features such as a building, bridge or mountain viewed from a particular perspective, human images including faces, or images of objects or articles such as a brand logo, a vegetable or fruit, or the like. The database 101 can be communicably coupled to (or alternatively integrated with) a visual search server data processing system 102, which is configured to process visual searches in the manner described below. The visual search server 102 can be coupled to a user device 105 (also referred to as user equipment (UE) or a mobile station (MS)) for receipt of visual searches/queries from and delivery of visual search results. The visual search server 102 can be coupled to a user device 105 by a communications network, such as the Internet 103 and a wireless communications system including a base station (BS) 104. As noted above, the user device 105 can be a “smart” phone or tablet device capable of functions other than wireless voice communications, including at least playing video content. Alternatively, the user device 105 can be a laptop computer or other wireless device having a camera or display and/or capable of requesting a visual search.

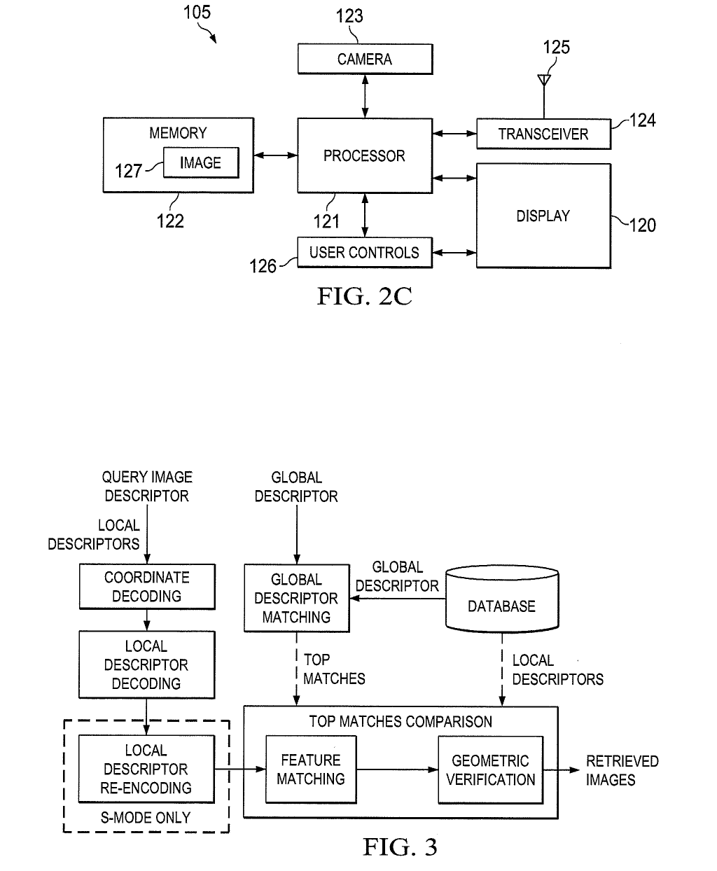

FIG. 2A illustrates a high level block diagram of the functional components of the visual search server from the network 100 of FIG. 1, while FIG. 2B illustrates a front view of wireless device from the network 100 of FIG. 1 and FIG. 2C illustrates a high level block diagram of the functional components of that wireless device 105.

With respect to FIG. 2A, visual search server 102 can include one or more processors 110 coupled to a network connection 111 over which signals corresponding to visual search requests can be received and signals corresponding to visual search results can be selectively transmitted. The visual search server 102 can also include memory 112 storing an instruction sequence for processing visual search requests, and data used in the processing of visual search requests. The memory 112 in the example shown can include a communications interface for connection to image database 101.

With respect to FIGS. 2B and 2C, user device 105 can be a mobile phone and can include an optical sensor (not visible in the view of FIG. 2B) configured to capture images and a display 120 on which captured images can be displayed. A processor 121 can be coupled to the display 120 controls content displayed on the display. The processor 121 and other components within the user device 105 can be either powered by a battery (not shown), which can be recharged by an external power source (also not shown), or alternatively by the external power source. A memory 122 can be coupled to the processor 121 can be configured to store or buffer image content for playback or display by the processor 121 and display on the display 120, and can also store an image display and/or video player application (or “app”) 122 for performing such playback or display. The image content being played or displayed can be captured using camera 123 (which includes the above-described optical sensor) or received, either contemporaneously (such as overlapping in time) with the playback or display or prior to the playback/display, via transceiver 124 connected to antenna 125—such as a Short Message Service (SMS) “picture message.” User controls 126 (such as buttons or touch screen controls displayed on the display 120) can be employed by the user to control the operation of mobile device 105 in accordance with known techniques.

Mobile visual search and Augmented Reality (AR) applications can utilize compact descriptors that are robust to image recapturing variations and efficient for indexing and query transmission over the air. This is part of the on-going MPEG standardization effort known as Compact Descriptors for Visual Search (CDVS). The typical query processing with CDVS is illustrated in the exemplary embodiment of FIG. 3.

As illustrated in FIG. 3, a query image can be used to search a large database of images to find images with similar content. The search can be executed by matching the query image to the database images where the matching can be performed using salient information extracted from the images. In certain embodiments, this salient information of an image can be a combination of the local descriptors as well as the global descriptors that are extracted from the image. The local descriptors characterize different small regions of an image and the global descriptors characterize the whole image in an overall sense.

Several different types of global descriptors can be used in the computer vision literature, such as GIST, Vector of Locally Aggregated Descriptors (VLAD), Compressed Fisher Vector (CFV), Residual Enhanced Visual Vectors (REVV), or the like. In an embodiment, one such global descriptor can be the Scalable Compressed Fisher Vector (SCFV).

The SCFV is a compact discriminative global descriptor that is constructed by aggregating the local feature descriptors of an image producing a fast and efficient search. The SCFV is based on the CFV global descriptor. The SCFV can be constructed in essentially two stages: the Offline Stage where a Gaussian Mixture Model (GMM) is trained using SIFT descriptors of an MIRFLICKER dataset and the Online Stage where a scalable fisher vector aggregation method occurs.

In the Offline Stage, a GMM model is trained using a training set of SIFT features. The GMM training results in a set of GMM parameters λ={wᵢ, uᵢ, σᵢ, i=1 . . . 128}, where wᵢ, uᵢ and σᵢ denote the mixture weight, mean vector and variance of the i-th Gaussian cluster. In a subsequent online stage, the GMM model can be employed to generate the Fisher Vector for each selected local feature from the stage of keypoint selection in query/reference images.

In the Online Stage, a SCFV aggregation method occurs. However, before discussing SCFV, a Compressed Fisher Vector (CFV) aggregation method will be discussed so that a CFV aggregation method can be compared with a SCFV aggregation. For the CFV method, let X={xₜ, t=1 . . . T} denote the set of local feature descriptors in an image, and let the offline trained GMM model consist of K Gaussian functions. Then the image likelihood can be represented as L(X|λ)=log p(X|λ)=Σₜ₌₁^{T} log p(xₜ|λ), the likelihood of each feature descriptor xₜ being p(xₜ|λ)=Σᵢ₌₁^{K} wᵢpᵢ(xₜ|λ), where pᵢ refers to the i-th Gaussian function.

Given the local descriptor xₜ, the Gaussian GMM mode assignment probability γₜ(i) (such as the probability of xₜ being generated by the i-th Gaussian function) is given by

$${γ}_{t} ( i ) = p ( i \vert {x}_{t} , λ ) = \frac{{w}_{i} {p}_{i} ( {x}_{t} \vert λ )}{{\sum }_{j = 1}^{K} {w}_{j} {p}_{j} ( {x}_{t} \vert λ )} \qquad ( 1 )$$

In the CFV aggregation method, first the gradient vector of p(xₜ|λ) is calculated for each local descriptor, with regards to each Gaussian function pᵢ. Then the gradient vectors (partial derivatives) of p(xₜ|λ) are accumulated for all the selected keypoints' local descriptors in the image, with regards to each Gaussian function pᵢ, in the analytical form as below:

$${g}_{i}^{X} = \frac{\partial ℒ ( X \vert λ )}{\partial {u}_{i}} = \frac{1}{\sqrt{{w}_{i}}} {\sum }_{t = 1}^{T} {γ}_{t} ( i ) ( \frac{{x}_{t} - {u}_{i}}{{σ}_{i}} ) \qquad ( 2 )$$

Finally, by concatenating the accumulated gradient vectors gᵢ^{X} of all Gaussian functions, the aggregated CFV can be generated. For the convenience of subsequent explanation, gᵢ^{X} is referred henceforth as Fisher Vector (FV) sub-vector.

In the CFV aggregation method, the final global descriptor includes concatenated FV sub-vectors from all the K Gaussian functions or clusters. Conversely, the SCFV aggregation method does not include all the K FV sub-vectors in the final aggregation. Instead, the SCFV aggregation method filters out contributions from some Gaussian functions based on the property of rich sparseness inherent to the Fisher Vector aggregation method.

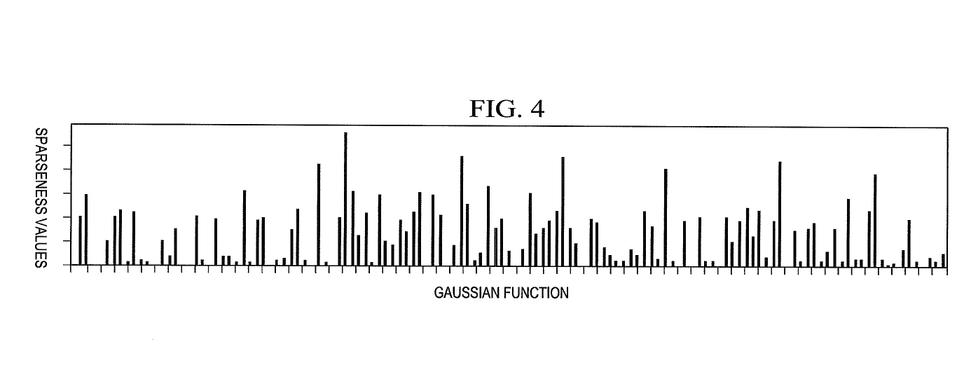

FIG. 4 illustrates an exemplary embodiment of sparseness values of the K FV sub-vectors gᵢ^{X} according to this disclosure. The embodiment of the sparseness values shown in FIG. 4 is for illustration only. Other embodiments could be used without departing from the scope of the present disclosure.

Lower sparseness values indicate that the corresponding FV sub-vectors are less useful. In certain embodiments, in order to construct a discriminative and compact global descriptor, the sparseness values can be thresholded to select a few informative Gaussian functions. Using the selected few thresholded sparseness values, the corresponding FV sub-vectors of the Gaussian functions can be determined and concatenated to form the Scalable Compressed Fisher Vector (SCFV). This is known as the Gaussian cluster selection criterion. The SCFV aggregation based global descriptor may use distinct sets of Gaussian functions to represent different images. However, this is taken into account at the time of pair-wise matching between the SCFV descriptors where only the Gaussian functions that are common to both the SCFVs are used in computing the global match score.

In the previous implementation of the SCFV, the sparseness value for i-th Gaussian function is computed as the maximum probability max_{0≦t≦T} γₜ(i) of the selected local features in an image. For those Gaussian functions that pass the sparseness criterion, their FV sub-vectors are concatenated to form the SCFV. In a formal way, the sparseness thresholding works as follows:

$${g}_{i}^{X} = \frac{h ( i )}{\sqrt{{w}_{i}}} {\sum }_{t = 1}^{T} {γ}_{t} ( i ) ( \frac{{x}_{t} - {u}_{i}}{{σ}_{i}} ) , \\ where \\ h ( i ) = \{ \begin{matrix}1 & if {max}_{0 \leq t \leq T} {γ}_{t} ( i ) > τ , \\ 0 & otherwise .\end{matrix} \qquad ( 3 )$$

However, there are some drawbacks in the Gaussian function selection criteria in this previous SCFV aggregation method. It is understood that the cluster selection criterion is an important factor in determining which Gaussian functions contribute to the final SCFV. The number of Gaussian functions that are selected by the selection criterion and specifically which Gaussian functions are selected by the selection criteria has a direct impact on the size of the SCFV global descriptor as well as an impact on its discriminative power. Therefore, it is essential that the selection criterion picks “good-quality” Gaussian functions that increase the discriminative ability of the descriptor rather than selecting noisy Gaussians functions, which reduce the discriminative power as well as add to the size of the SCFV descriptor.

In the previous SCFV implementation, the i-th Gaussian function is selected if the maximum probability of a local descriptor being generated from the i-th Gaussian function exceeds the threshold τ. Formally described as max_{0≦t≦T} γₜ(i)>τ such as for the set of local feature descriptors of the image. This criterion has the disadvantage that it only depends on one local feature, the one that is nearest to the mean of the i-th Gaussian function in the feature space. If the local feature is close enough to the mean of the Gaussian function, then that function is included in SCFV aggregation. The drawback here is that just one local feature determines the importance of a Gaussian function. There may be some spurious Gaussian functions that have only one local feature close to their means and the other local features may be far away. Such Gaussian functions would erroneously be preferred over other Gaussian functions that have a higher probability of generating the local features but whose means are farther away from the nearest local features.

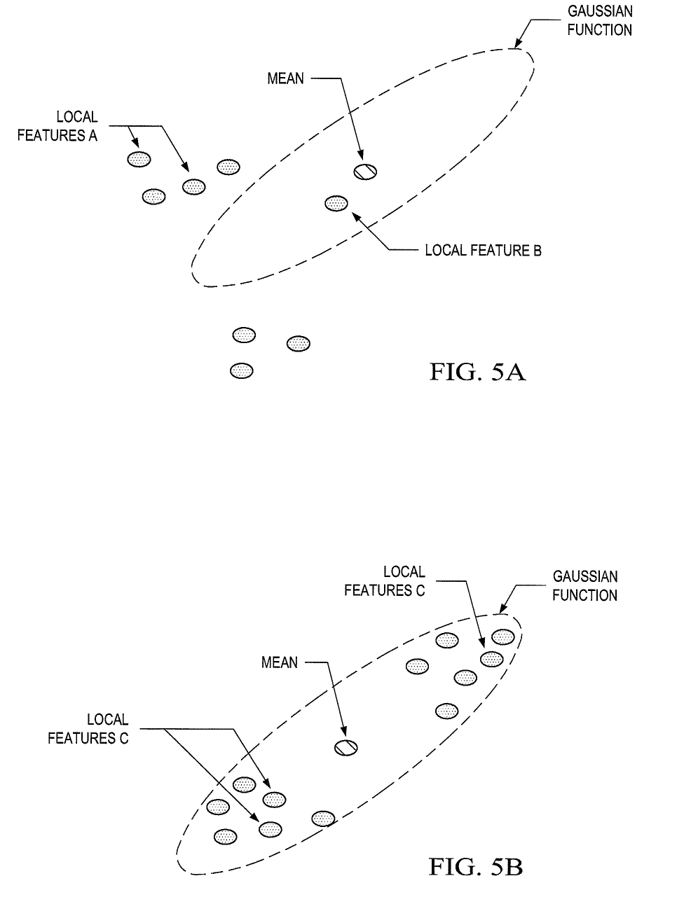

FIGS. 5A and 5B illustrate exemplary embodiments of a previous SCFV implementation according to this disclosure. The embodiments of the SCFV shown in FIGS. 5A and 5B are for illustration only. Other embodiments could be used without departing from the scope of the present disclosure.

In the previous SCFV implementation only one local feature determines the importance of a Gaussian function. For example, FIG. 5A illustrates a plurality of local features “A” located a far distance away from the mean of the Gaussian function and outside the boundary illustrating the Gaussian function or cluster. Furthermore, FIG. 5A illustrates a single local feature “B” located at a short distance from the mean Gaussian function and within the boundary illustrating the Gaussian function or cluster. Conversely, FIG. 5B illustrates a plurality of local features “C” all of which are located a distance further from the mean Gaussian function than the distance from single local feature “B” to the mean Gaussian function illustrated in FIG. 5A. Furthermore, the plurality of local features “C” are also located a shorter distance from the mean of the Gaussian function than the distance from any of the plurality of local features “A” to the mean of the Gaussian function illustrated in FIG. 5A. The further the distance that the local features are from the mean of a Gaussian function the lower the probability that the Gaussian function or cluster represents useful information about the image. Conversely, the closer the distance that the local features are from the mean of a Gaussian function the higher the probability that the Gaussian function or cluster represents useful information about the image.

With respect to FIGS. 5A and 5B, even though FIG. 5B illustrates a Gaussian function with more local features (such as local features “C”) closer to the mean of the Gaussian function, the Gaussian function selection criteria of this previous SCFV implementation may prefer the Gaussian function illustrated in FIG. 5A over the Gaussian function illustrated in FIG. 5B for SCFV aggregation. The cluster selection criteria of this previous SCFV implementation may prefer the Gaussian function illustrated in FIG. 5A because the cluster selection criteria of this previous SCFV implementation only depends on one local feature. Thus, the cluster selection criteria of this previous SCFV implementation can eliminate some highly informative Gaussian functions or clusters (such as cluster having a high probability of capturing useful information about the image) with a plurality of good local features (such as local features close to the mean of the Gaussian function) and instead select less informative Gaussian functions or clusters (such as clusters having a lower probability of capturing useful information about the image) because the less informative cluster includes one local feature that is closer to the mean Gaussian function than any of the local features of the more informative cluster.

To overcome the limitations of the previous cluster selection criterion, a cluster selection criteria can be generalized not only to consider the local feature with the maximum posteriori probability γₜ(i) but the top n local features which have the highest γₜ(i) values. The previous criterion can be expressed as

γ_{[1]}(i)>τ (4)

where γ_{[1]}(i) represents the first order statistic and is equal to max_{0≦t≦T} γₜ(i). An improved criterion can be expressed as

Σⱼ₌₁ⁿγ_{[j]}(i)>τ′ (5)

where γ_{[1]}(i)≧γ_{[2]}(i)≧γ_{[3]}(i)≧ . . . . Here, n can take different integer values. For example, top 5, 10 or 20 local features may be considered. The modified criterion ensures that a Gaussian function gets selected based on multiple local features that are closest to the Gaussian function mean. Therefore a Gaussian function with more local features as its members will be preferred during the selection stage.

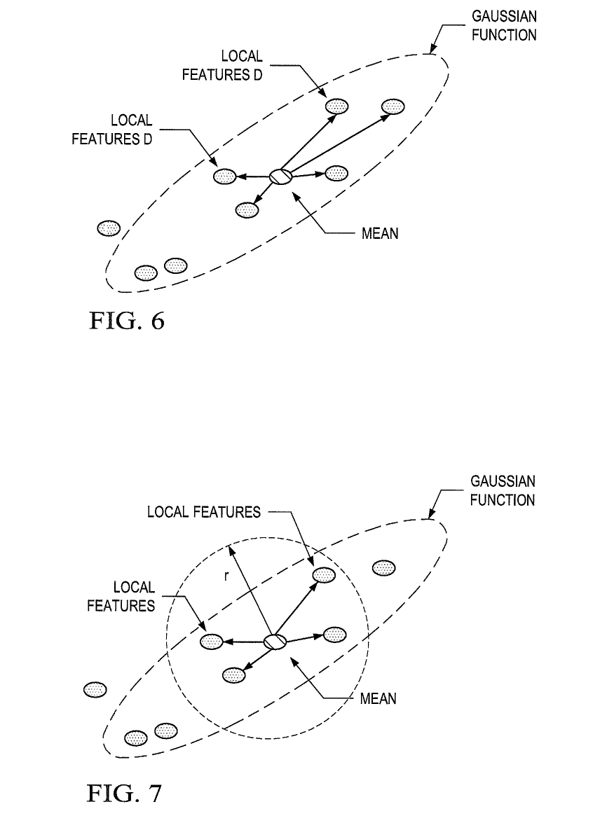

FIG. 6 illustrates an exemplary embodiment of a Gaussian function selection criteria according to this disclosure. The embodiment of the Gaussian function selection criteria shown in FIG. 6 is for illustration only. Other embodiments could be used without departing from the scope of the present disclosure. As shown in FIG. 6, the Gaussian function selection criteria considers the top-n local features “D” with the highest probability of being generated from the Gaussian function.

In certain embodiments, a Gaussian function can be selected based on a count of the number of local features that have a high probability of being generated from that Gaussian function. For the i-th Gaussian, the number of local features whose posterior probability is greater than a threshold τ″ is given by:

nᵢ=Σₜ₌₁^{T}∥(γₜ(i)>τ″) (6)

where ∥(•) is an indicator function. The Gaussian functions can be sorted in descending order of nᵢ's and certain top Gaussian functions can be selected for inclusion in the SCFV descriptor.

FIG. 7 illustrates an embodiment of Gaussian function selection criteria based on counting the number of local features that have a probability of being generated from the Gaussian above a certain threshold according to this disclosure. The embodiment of the Gaussian function shown in FIG. 7 is for illustration only. Other embodiments could be used without departing from the scope of the present disclosure. As illustrated in FIG. 7, the number of local features which can used in the selection criteria can be determined by the number of local features that are at or within a distance “r” from the Gaussian function mean.

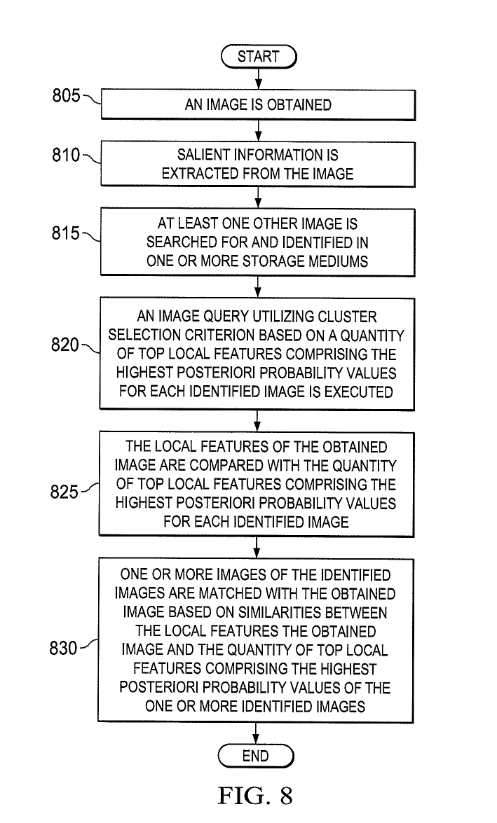

FIG. 8 illustrates an embodiment of an image query execution method 800 according to this disclosure. While the flow chart depicts a series of sequential steps, unless explicitly stated, no inference should be drawn from that sequence regarding specific order of performance, performance of steps or portions thereof serially rather than concurrently or in an overlapping manner, or performance of the steps depicted exclusively without the occurrence of intervening or intermediate steps. The process depicted in the example depicted is implemented by a transmitter chain in, for example, a mobile station.

At step 805, an image can be obtained by a wireless communication device. The image can be obtained by the wireless communication device by downloading the image via a wireless connection or wired connection (such as from another electronic device). The image can also be obtained by capturing an image of an environment via camera 352 (as shown in FIG. 2C).

At step 810, the wireless communication device can extract salient information from the image. Salient information can include local features or global features of the image. At step 815, the wireless communication device can search through one or more storage mediums (such as a server in communication with a wireless network) and identify one or more images to be queried. At step 820, the wireless communication device can execute an image query utilizing cluster selection criterion based on a number of top local features comprising the posteriori probability values greater than a predetermined threshold for each identified image. In another embodiment, the cluster selection criteria is based on sum of the posteriori probability values of a predetermined number of local features having the highest posteriori probability values.

At step 825, the global descriptor generated using the cluster selection criteria is sent to a remote server along with the local descriptors and other information such as keypoint location coordinates etc. At step 830, the remote server matches one or more identified images with the images from a database using a predetermined criteria involving local and global descriptors and transmits the matched images and/or any related information to the wireless device. In certain embodiments, the wireless communication device can present the matched one or more identified images on a display screen. It should be obvious that the proposed cluster selection criteria may also be used while extracting the global descriptors from the images from the image database associated with the remote server.

Mobile visual search and augmented reality (AR) applications are gaining momentum and the underlying technology research is attracting major players across the industry spectrum. The on-going MPEG standardization effort on Compact Descriptors for Visual Search (CDVS) is the main venue for visual search and AR technology enabler research. The technical benefits of this disclosure provide more compact and more discriminative global descriptors for image matching and image retrieval simulations. The embodiments of this disclosure are configured to improve the performance of the Test Model in Compact Descriptors for Visual Search (CDVS).

In certain embodiments, various functions described above are implemented or supported by one or more computer programs, each of which is formed from computer readable program code and embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A wireless communication device comprising:
a processor configured to:
execute an image query utilizing cluster selection criterion for a cluster-aggregation based vectorization of a set of local features based on a quantity of top local features comprising the highest posteriori probability values,
wherein the cluster selection criterion is measured as the summation of the posteriori probability values of the top local features, wherein the quantity of top local features is determined by a predetermined integer value greater than one.

2. The wireless communication device of claim 1, wherein utilizing the cluster selection criteria comprises obtaining an image by the wireless communication device and extracting, by the wireless communication device, local features from the image.

3. The wireless communication device of claim 1, wherein utilizing the cluster selection criteria comprises identifying, by the wireless communication device, the quantity of top local features comprising the highest posteriori probability values for each of a plurality of images to be searched.

4. The wireless communication device of claim 1, wherein the quantity of top local features comprising the highest posteriori probability values comprises local features closest to a cluster mean.

5. The wireless communication device of claim 1, wherein the wireless communication device is configured to receive one or more images that have matching local and global descriptors to the image query, wherein the global descriptors of the images are computed based on the Gaussian cluster selection criteria using the summation of the posteriori probability values of the top local features.

6. A method of executing an image query using a wireless communication device, the method comprising:
utilizing a cluster selection criterion for a cluster-aggregation based vectorization of a set of local features based on a quantity of top local features comprising the highest posteriori probability values; and
wherein the cluster selection criterion is measured as the summation of the posteriori probability values of the top local features, wherein the quantity of top local features is determined by a predetermined integer value greater than one.

7. The method of claim 6, wherein utilizing the cluster selection criteria comprises obtaining an image by the wireless communication device and extracting, by the wireless communication device, local features from the image.

8. The method of claim 6, wherein utilizing the cluster selection criteria comprises identifying, by the wireless communication device, the quantity of top local features comprising the highest posteriori probability values for each of a plurality of images to be searched.

9. The method of claim 6, wherein the quantity of top local features comprising the highest posteriori probability values comprises local features closest to a cluster mean.

10. The method of claim 6, further comprising receiving one or more images that have matching local and global descriptors to the image query, wherein the global descriptors for the images are computed based on the Gaussian cluster selection criterion using the summation of the posteriori probability values of the top local features.

11. A wireless communication device comprising:
a processor configured to:
execute an image query utilizing cluster selection criterion for a cluster-aggregation based vectorization of a set of local features based on a quantity of top local features comprising the highest posteriori probability values, and
measure the summation of the posteriori probability values of the top local features, wherein the quantity of top local features is determined by a quantity of local features that have a posterior probability value greater than a posterior probability value threshold.

12. The wireless communication device of claim 11, wherein utilizing the cluster selection criteria comprises obtaining an image by the wireless communication device and extracting, by the wireless communication device, local features from the image.

13. The wireless communication device of claim 11, wherein utilizing the cluster selection criteria comprises identifying, by the wireless communication device, the quantity of top local features comprising the highest posteriori probability values for each of a plurality of searched images.

14. The wireless communication device of claim 11, wherein the quantity of top local features comprising the highest posteriori probability values comprises local features closest to a cluster mean.

15. The wireless communication device of claim 11, wherein the wireless communication device is configured to receive one or more images that have matching local and global descriptors to the image query, wherein the global descriptors for the images are computed based on the Gaussian cluster selection criterion using the summation of the posteriori probability values of the top local features.

16. A method of executing an image query using a wireless communication device, the method comprising:
utilizing a cluster selection criterion for a cluster-aggregation based vectorization of a set of local features based on a quantity of top local features comprising the highest posteriori probability values; and
measuring the summation of the posteriori probability values of the top local features, wherein the quantity of top local features is determined by a quantity of local features that have a posterior probability value greater than a posteriori probability value threshold.

17. The method of claim 16, wherein utilizing the cluster selection criteria comprises obtaining an image by the wireless communication device and extracting, by the wireless communication device, local features from the image.

18. The method of claim 16, wherein utilizing the cluster selection criteria comprises identifying, by the wireless communication device, the quantity of top local features comprising the highest posteriori probability values for each of a plurality of searched images.

19. The method of claim 16, wherein the quantity of top local features comprising the highest posteriori probability values comprises local features closest to a cluster mean.

20. The method of claim 16, further comprising receiving one or more images that have matching local and global descriptors to the image query, where the global descriptors for the images are computed based on the Gaussian cluster selection criterion using the summation of the posteriori probability values of the top local features.
